(19) United States
(12) Patent Application Publication
(10) Pub. No.: US 2021/0136340 A1
(43) Pub. Date: May 6, 2021

(54) COLOR TEMPERATURE ADJUSTMENT METHOD, CONTROL TERMINAL, AND MOVABLE PLATFORM

(71) Applicants: SZ DJI TECHNOLOGY CO., LTD., Beijing (CN); DAJIANG MUTUAL ENTERTAINMENT TECHNOLOGY (BEIJING) CO., LTD., Beijing (CN)

(72) Inventor: Yinglai XI, Shenzhen (CN)

(21) Appl. No.: 17/148,033

(22) Filed: Jan. 13, 2021

Related U.S. Application Data
(63) Continuation of application No. PCT/CN2018/096314, filed on Jul. 19, 2018.

(51) Int. Cl. H04N 9/73; H04N 9/76; H04N 5/262

(52) U.S. Cl. CPC H04N 9/735; H04N 5/2621; H04N 9/76

(57) ABSTRACT

A color temperature adjustment method includes obtaining an image to be adjusted, determining a pixel value gain of a pixel in the image according to a pixel value of the pixel and a preset gain-value correspondence between the pixel value and the pixel value gain, and adjusting a color temperature of the pixel according to the pixel value and the pixel value gain of the pixel, and a color temperature adjustment ratio.

### CROSS-REFERENCE TO RELATED APPLICATION

This application is a continuation of International Application No. PCT/CN2018/096314, filed Jul. 19, 2018, the entire content of which is incorporated herein by reference.

### TECHNICAL FIELD

The present disclosure relates to image processing and, more particularly, to a color temperature adjustment method, a control terminal, and a movable platform.

### BACKGROUND

With the development of Internet technology, the consumption of video entertainment and video content tends to be popularized, and the demand of video content authors for video editing is increasing. The manual video editor has become a popular software APP on mobile terminals, providing a personalized tool for video enthusiasts to freely edit videos. Among them, color temperature adjustment is one of the important functions in video editing. The color temperature adjustment method in the existing technologies generally first estimates the color temperature of an image, then determines an adjustment coefficient of each in the three color channels according to an isothermal map interpolation, that is, determines an adjustment coefficient of a red channel (R channel), an adjustment coefficient of a green channel (G channel), and an adjustment coefficient of a blue channel (B channel), and then adjusts the color temperature according to the adjustment coefficients in the three color channels. However, in the existing technologies, the color temperature of the image needs to be estimated first, and the process of estimating the color temperature is complicated, which results in low color temperature adjustment efficiency.

### SUMMARY

In accordance with the disclosure, there is provided a color temperature adjustment method including obtaining an image to be adjusted, determining a pixel value gain of a pixel in the image according to a pixel value of the pixel and a preset gain-value correspondence between the pixel value and the pixel value gain, and adjusting a color temperature of the pixel according to the pixel value and the pixel value gain of the pixel, and a color temperature adjustment ratio.

Also in accordance with the disclosure, there is provided a control terminal including a memory storing a preset gain-value correspondence between a pixel value and a pixel value gain, a communication device configured to receive an image sent by a movable platform, and a processor configured to determine a pixel value gain of a pixel in the image according to a pixel value of the pixel and the preset gain-value correspondence, and adjust a color temperature of the pixel according to the pixel value and the pixel value gain of the pixel, and a color temperature adjustment ratio.

Also in accordance with the disclosure, there is provided a movable platform including a photographing device configured to capture an image, a memory storing a preset gain-value correspondence between a pixel value and a pixel value gain, and a processor configured to determine a pixel value gain of a pixel in the image according to a pixel value of the pixel and the preset gain-value correspondence, and adjust a color temperature of the pixel according to the pixel value and the pixel value gain of the pixel, and a color temperature adjustment ratio.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts.

FIG. 1 is a schematic structural diagram of an unmanned aerial system according to an embodiment of the disclosure.

FIG. 2 is a schematic flowchart of a color temperature adjustment method according to an embodiment of the disclosure.

FIG. 3 is a schematic diagram showing smooth curves of pixel values and pixel value gains corresponding to three color channels when a color temperature increases according to an embodiment of the disclosure.

FIG. 4 is a schematic diagram showing smooth curves of pixel values and pixel value gains corresponding to three color channels when a color temperature decreases according to an embodiment of the disclosure.

FIG. 5 is a schematic structural diagram of a control terminal according to an embodiment of the disclosure.

FIG. 6 is a schematic structural diagram of a movable platform according to an embodiment of the disclosure.

### DETAILED DESCRIPTION OF THE EMBODIMENTS

The technical solutions in the example embodiments of the present disclosure will be described clearly with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

Example embodiments will be described with reference to the accompanying drawings. In the case of no conflict, the following embodiments and features in the embodiments can be combined with each other.

The embodiments of the present disclosure provide a color temperature adjustment method, a device and a movable platform. The movable platform may include an unmanned aerial vehicle (UAV), an unmanned ship, an unmanned vehicle, or a robot, etc. The UAV may be a rotorcraft, for example, a multi-rotor aircraft propelled by multiple propulsion devices through the air, which is not limited in the embodiments.

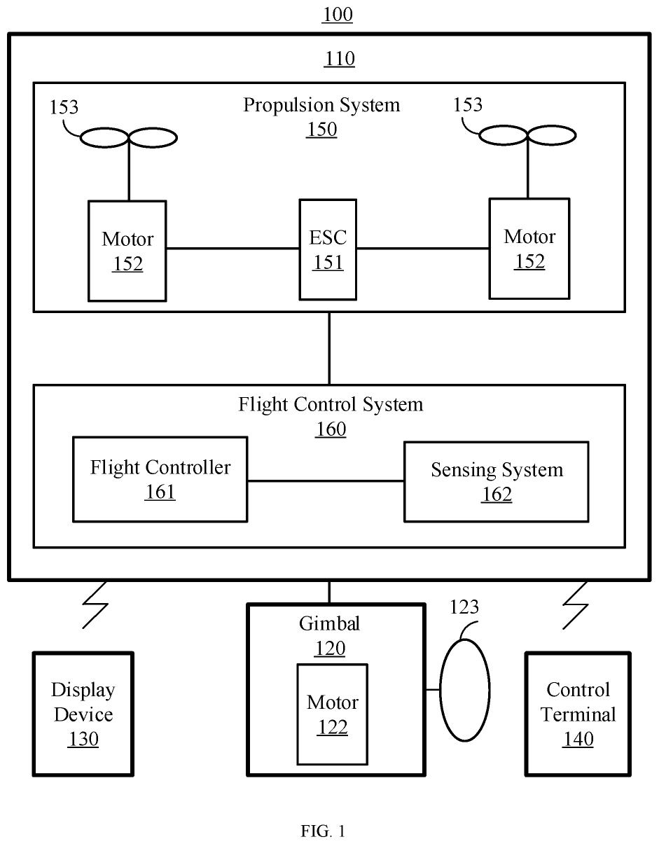

FIG. 1 is a schematic structural diagram of an unmanned aerial system according to an embodiment of the disclosure. In the embodiments, a rotor UAV is taken as an example for description.

An unmanned aerial system 100 includes a UAV 110, a display device 130, and a control terminal 140. The UAV 110 includes a propulsion system 150, a flight control system 160, a frame, and a gimbal 120 carried at the frame. The UAV 110 can wirelessly communicate with the control terminal 140 and the display device 130.

The frame may include a body and a stand (also referred to as “landing gear”). The body may include a center frame and one or more arms connected to the center frame, and the one or more arms extend radially from the center frame. The stand is connected to the body, and is used for supporting the UAV 110 when landing.

The propulsion system 150 includes one or more electronic speed controls (ESCs) 151, one or more propellers 153, and one or more motors 152 corresponding to the one or more propellers 153. The motor 152 is connected between the ESC 151 and the propeller 153, and the motor 152 and the propeller 153 are disposed at the arm of the UAV 110. The ESC 151 receives a drive signal generated by the flight control system 160 and provides a drive current according to the drive signal to the motor 152 to control a speed of the motor 152. The motor 152 drives the propeller to rotate, so as to provide power for the flight of the UAV 110, and the power enables the UAV 110 to achieve one or more degrees of freedom of movement. In some embodiments, the UAV 110 may rotate about one or more rotation axes. For example, the rotation axis may include a roll axis, a yaw axis, or a pitch axis. The motor 152 may be a DC motor or an AC motor. Further, the motor 152 may be a brushless motor or a brushed motor.

The flight control system 160 includes a flight controller 161 and a sensing system 162. The sensing system 162 is used to measure attitude information of the UAV, that is, position information and state information of the UAV 110 in space, for example, a three-dimensional position, a three-dimensional angle, a three-dimensional velocity, a three-dimensional acceleration, and a three-dimensional angular velocity. The sensing system 162 may include, for example, at least one of sensors such as a gyroscope, an ultrasonic sensor, an electronic compass, an inertial measurement unit (IMU), a vision sensor, a global navigation satellite system, or a barometer. For example, the global navigation satellite system may be a global positioning system (GPS). The flight controller 161 is used to control the flight of the UAV 110, for example, it can control the flight of the UAV 110 according to the attitude information measured by the sensor system 162. The flight controller 161 can control the UAV 110 according to pre-programmed program instructions, and can also control the UAV 110 by responding to one or more control instructions from the control terminal 140.

The gimbal 120 includes a motor 122. The gimbal is used to carry a photographing device 123. The flight controller 161 can control a movement of the gimbal 120 through the motor 122. In some embodiments, the gimbal 120 may further include a controller for controlling the movement of the gimbal 120 by controlling the motor 122. The gimbal 120 may be independent of the UAV 110 or a part of the UAV 110. The motor 122 may be a DC motor or an AC motor. Further, the motor 122 may be a brushless motor or a brushed motor. The gimbal may be disposed at a top of the UAV or at a bottom of the UAV.

The photographing device 123 may be, for example, a device for capturing images, such as a camera or a video camera, and the photographing device 123 may communicate with the flight controller and shoot pictures under the control of the flight controller. The photographing device 123 of the embodiments at least includes a photosensitive element, and the photosensitive element is, for example, a complementary metal oxide semiconductor (CMOS) sensor or a charge-coupled device (CCD) sensor. The photographing 123 can also be directly fixed at the UAV 110, therefore the gimbal 120 can be removed.

The display device 130 is located at a ground terminal of the unmanned aerial system 100, can communicate with the UAV 110 in a wireless manner, and can be used to display the attitude information of the UAV 110. Further, the image shot by the photographing device may also be displayed at the display device 130. The display device 130 may be an independent device or integrated in the control terminal 140.

The control terminal 140 is located at the ground terminal of the unmanned aerial system 100, and can communicate with the UAV 110 in a wireless manner for a remote control of the UAV 110.

Further, the UAV 110 may also be provided with a speaker (not shown in the figure) on board, and the speaker is used to play audio files. The speaker can be directly fixed at the UAV 110 or mounted at the gimbal 120.

The above naming of the components of the unmanned aerial system is only for identification purposes and should not be understood as a limitation to the embodiments of the present disclosure.

The color temperature adjustment method of various embodiments of the present disclosure can be used to adjust color temperatures of images captured by the photographing device, but it is not limited thereto. In the following, the present disclosure is described by taking a UAV as an example of the movable platform.

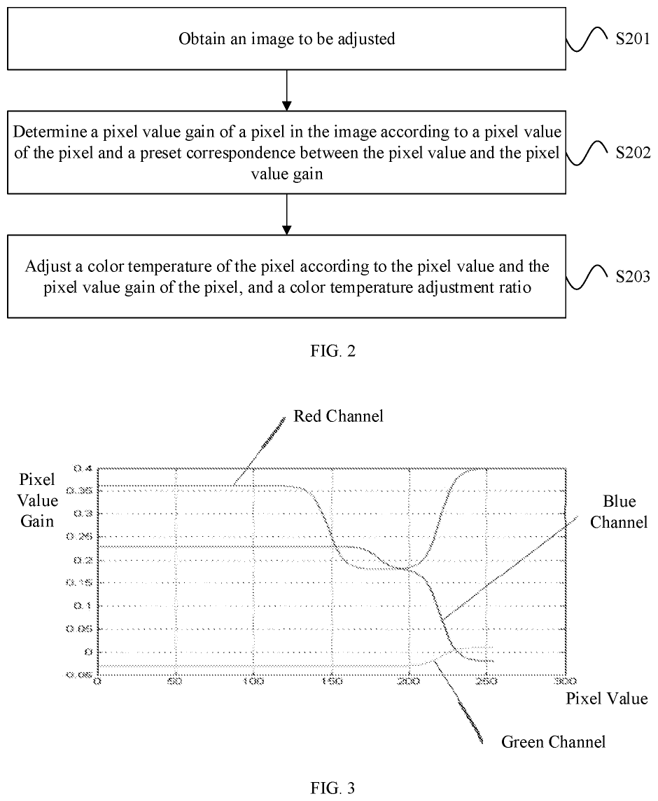

FIG. 2 is a flowchart of a color temperature adjustment method according to an embodiment of the present disclosure. As shown in FIG. 1, the method of the embodiments can be applied to a UAV or a control terminal.

At S201, an image to be adjusted is obtained.

In some embodiments, an image whose color temperature is to be adjusted is obtained, and the image may be a video image.

If the method of the embodiments is applied to a control terminal, a control terminal of a UAV is taken as an example for description, which is not limited. The control terminal obtaining an image to be adjusted may include receiving an image shot and sent by the UAV, or obtaining an image saved in the control terminal, or obtaining an image sent by another device, or obtaining an image shot by a photographing device at the control terminal. If the method of the embodiments is applied to a UAV, the UAV obtaining the image to be adjusted may include controlling the photographing device at the UAV to shoot the image.

The control terminal includes one or more of a remote control, a smart phone, a tablet computer, a laptop computer, or a wearable device, which is not described in detail here.

At S202, a pixel value gain of a pixel in the image is determined according to a pixel value of the pixel and a preset correspondence between the pixel value and the pixel value gain.

In some embodiments, the correspondence between the pixel value and the pixel value gain is preset, and the preset correspondence between the pixel value and the pixel value gain can be stored in advance at the control terminal, or stored in advance at the UAV. In this disclosure, the correspondence between the pixel value and the pixel value gain is also referred to as a “gain-value correspondence.”

After the image to be adjusted is obtained, the pixel value gain of each of one or more pixels in the image is determined according to the pixel value of the pixel and the preset correspondence between the pixel value and the pixel value gain. The pixel value gain of a pixel can be used to adjust the color temperature of the pixel.

At S203, the color temperature of the pixel is adjusted according to the pixel value and the pixel value gain of the pixel, and a color temperature adjustment ratio.

In some embodiments, after the pixel value gain of a pixel in the image is determined, the color temperature of the pixel is adjusted according to the pixel value of the pixel, the pixel value gain determined at S202, and the color temperature adjustment ratio, so as to obtain an image after color temperature adjustment (also referred to as an “adjusted image”). The color temperature adjustment ratio is used to indicate a degree of color temperature adjustment. The value of the color temperature adjustment ratio is between, for example, −100% to 100%. If the color temperature adjustment ratio is negative, it means decreasing the color temperature. If the color temperature adjustment ratio is positive, it means increasing the color temperature.

A possible implementation manner of the above-described process S203 is adjusting the color temperature of a pixel through following formula:

$$\{ \begin{matrix}R = ( 1 + c * {gain}_{r} ) * r \\ G = ( 1 + c * {gain}_{g} ) * g \\ B = ( 1 + c * {gain}_{b} ) * b\end{matrix}$$

where R denotes a color temperature of a red channel of a pixel after color temperature adjustment, G denotes a color temperature of a green channel of the pixel after color temperature adjustment, B denotes a color temperature of a blue channel of the pixel after color temperature adjustment, r denotes a color temperature of the red channel of the pixel before color temperature adjustment , g denotes a color temperature of the green channel of the pixel before color temperature adjustment, b denotes a color temperature of the blue channel of the pixel before color temperature adjustment, c denotes a color temperature adjustment ratio, gainᵣ denotes a pixel value gain of the red channel, gain_{g} denotes a pixel value gain of the green channel, and gain_{b} denotes a pixel value gain of the blue channel.

If the embodiments are applied to a control terminal, the color temperature adjustment ratio may be determined according to a color temperature adjustment operation input by a user and detected by the control terminal through an interactive device. The interactive device can be an important part of the control terminal and an interface for interacting with the user. The user can control the UAV by operating the interactive device. When the user wishes to control the UAV, the user operates the interactive device of the control terminal, and the control terminal detects the user's operation through the interactive device. In some embodiments, when the user wishes to adjust the color temperature of the image shot by the UAV, the user performs the color temperature adjustment operation on the interactive device, and the interactive device detects the color temperature adjustment operation. Therefore, the control terminal can detect the user's color temperature adjustment operation through the interactive device. The interactive device can be, for example, one or more of a control terminal touch screen, a keyboard, a joystick, or a dial wheel. Further, the touch screen can also display all flight parameters of the UAV, and can display images shot by the UAV.

In some embodiments, after the control terminal executes process S203, the control terminal may also display an image after the color temperature adjustment.

If the embodiments are applied to a UAV, the color temperature adjustment ratio is received by the UAV and sent by the control terminal, and the color temperature adjustment ratio may be determined according to the color temperature adjustment operation input by the user and detected by the control terminal through the interactive device.

In some embodiments, after the UAV executes process S203, the UAV may also send the image after the color temperature adjustment to the control terminal, so that the control terminal can display the image after the color temperature adjustment.

In some embodiments, after the control terminal obtains the image after the color temperature adjustment, the user can share the image. When the user needs to share the image after the color temperature adjustment, the user can perform a sharing operation on the interactive device of the control terminal. The control terminal can detect the sharing operation through the interactive device, and after the user's sharing operation is detected through the interactive device, share a time-lapse video. For example, the control terminal can post the time-lapse video to a network (such as a social networking site, or a social app, etc.).

The image to be adjusted may be, for example, a video image captured by the photographing device in real time. Therefore, with the solution of the embodiments, the color temperature can be adjusted while the video image is captured, which can satisfy the need of real-time adjustment of the color temperature.

In the color temperature adjustment method according to the embodiments, the image to be adjusted is obtained, the pixel value gain of each of one or more pixels is determined according to the pixel value of the pixel in the image and the preset correspondence between the pixel value and the pixel value gain, and the color temperature of the pixel is adjusted according to the pixel value and the pixel value gain of the pixel, and the color temperature adjustment ratio. In the embodiments, a color temperature estimation process does not need to be performed, therefore a color temperature adjustment process is simplified and a color temperature adjustment efficiency is improved, which can satisfy the need of real-time adjustment of the color temperature.

In some embodiments, the above-described pixel value includes a pixel value in at least one color channel.

In some embodiments, the preset correspondence between the pixel value and the pixel value gain includes a preset correspondence between the pixel value and the pixel value gain in each color channel in the at least one color channel.

The at least one color channel is, for example, three color channels, and the three color channels are respectively a red channel, a green channel, and a blue channel, which is not limited. In some embodiments, at least one color channel may include a white channel.

The above embodiments are described in more detail below by taking three color channels as an example. The three color channels are red channel, green channel, and blue channel.

The preset correspondence between the pixel value and the pixel value gain includes a preset correspondence between the pixel value and the pixel value gain of the red channel, a preset correspondence between the pixel value and the pixel value gain of the green channel, and a preset correspondence between the pixel value of and the pixel value gain of the blue channel.

In some embodiments, the correspondences between the pixel values and the pixel value gains in the three color channels may include, for a color temperature adjustment ratio greater than a first value (first ratio value), a preset correspondence between the pixel value and the pixel value gain of the red channel, a preset correspondence between the pixel value and the pixel value gain of the green channel, and a preset correspondence between the pixel value and the pixel value gain of the blue channel. This means that if the color temperature adjustment ratio is greater than the first value, a first type of correspondence is used to determine the pixel value gain in each color channel.

In some embodiments, if the color temperature adjustment ratio at S203 is greater than the first value, the pixel value gain of the red channel of the pixel is determined according to the pixel value of the red channel of the pixel in the image, and the preset correspondence between the pixel value and the pixel value gain of the red channel for the color temperature adjustment ratio greater than the first value, the pixel value gain of the green channel of the pixel is determined according to the pixel value of the green channel of the pixel in the image, and the preset correspondence between the pixel value and the pixel value gain of the green channel for the color temperature adjustment ratio greater than the first value, and the pixel value gain of the blue channel of the pixel is determined according to the pixel value of the blue channel of the pixel in the image, and the preset correspondence between the pixel value and the pixel value gain of the blue channel for the color temperature adjustment ratio greater than the first value.

In some embodiments, the correspondences between the pixel values and the pixel value gains in the three color channels may include, for a color temperature adjustment ratio smaller than a second value (second ratio value), a preset correspondence between the pixel value and the pixel value gain of the red channel, a preset correspondence between the pixel value and the pixel value gain of the green channel, and a preset correspondence between the pixel value and the pixel value gain of the blue channel. This means that if the color temperature adjustment ratio is smaller than the second value, a second type of correspondence is used to determine the pixel value gain in each color channel.

In some embodiments, if the color temperature adjustment ratio at S203 is smaller than the second value, the pixel value gain of the red channel of the pixel is determined according to the pixel value of the red channel of the pixel in the image, and the preset correspondence between the pixel value and the pixel value gain of the red channel for the color temperature adjustment ratio smaller than the second value, the pixel value gain of the green channel of the pixel is determined according to the pixel value of the green channel of the pixel in the image, and the preset correspondence between the pixel value and the pixel value gain of the green channel for the color temperature adjustment ratio smaller than the second value, and the pixel value gain of the blue channel of the pixel is determined according to the pixel value of the blue channel of the pixel in the image, and the preset correspondence between the pixel value and the pixel value gain of the blue channel for the color temperature adjustment ratio smaller than the second value.

In some embodiments, the correspondences between the pixel values and the pixel value gains in the three color channels may include two types of correspondences. The first type of correspondence includes, for the color temperature adjustment ratio greater than the first value, the preset correspondence between the pixel value and the pixel value gain of the red channel, the preset correspondence between the pixel value and the pixel value gain of the green channel, and the preset correspondence between the pixel value and the pixel value gain of the blue channel. The second type of correspondence includes, for the color temperature adjustment ratio smaller than the second value, the preset correspondence between the pixel value and the pixel value gain of the red channel, the preset correspondence between the pixel value and the pixel value gain of the green channel, and the preset correspondence between the pixel value and the pixel value gain of the blue channel. In some embodiments, if the color temperature adjustment ratio at S203 is greater than the first value, the first type of correspondence is selected to determine the pixel value gain of the red channel, the pixel value gain of the green channel, and the pixel value gain of the blue channel of the pixel. If the color temperature adjustment ratio at S203 is smaller than the second value, the second type of correspondence is selected to determine the pixel value gain of the red channel, the pixel value gain of the green channel, and the pixel value gain of the blue channel of the pixel.

The second value is smaller than or equal to the first value. In some embodiments, the second value may be equal to the first value, for example, both are zero. Therefore, the correspondence required to obtain the pixel value gain in each color channel when the color temperature needs to be increased is different from the correspondence required to obtain the pixel value gain in each color channel when the color temperature needs to be decreased.

In some embodiments, when the color temperature adjustment ratio is greater than the first value, the preset correspondence between the pixel value and the pixel value gain of the red channel, the preset correspondence between the pixel value and the pixel value gain of the green channel, and the preset correspondence between the pixel value and the pixel value gain of the blue channel can be obtained through the following processes a-d.

At process a, a color temperature adjustment tool is used to increase the color temperature of a sample image by a preset color temperature adjustment ratio to obtain a sample image after color temperature adjustment (also referred to as an “adjusted sample image”).

In some embodiments, the color temperature adjustment tool (such as PhotoShop or CameraRAW) is used to adjust the color temperature of the sample image. In the embodiments, since the correspondence between the pixel value and the pixel value gain in the color channel to be obtained is for the color temperature adjustment ratio greater than the first value, the preset color temperature adjustment ratio in the embodiments is greater than the first value. For example, the first value is greater than 0, that is, the color temperature adjustment tool is used to increase the color temperature of the sample image by the preset color temperature adjustment ratio greater than the first value to obtain a sample image with an increased color temperature. In some embodiments, the preset color temperature adjustment ratio may be a maximum color temperature adjustment ratio of the color temperature adjustment tool.

At process b, for each color channel in the at least one color channel, a pixel value in the color channel of the pixel in the sample image after color temperature adjustment is obtained.

In the embodiments, after the sample image with the increased color temperature is obtained, the pixel value of the red channel of the pixel, the pixel value of the green channel of the pixel, and the pixel value of the blue channel of the pixel in the sample image with the increased color temperature are obtained.

At process c, the pixel value gain of the pixel in the color channel is determined according to the pixel value in the color channel of the pixel in the sample image after color temperature adjustment and the pixel value in the color channel of the pixel in the sample image before color temperature adjustment.

In the embodiments, the pixel value gain of the red channel of the pixel is determined according to the pixel value of the red channel of the pixel in the sample image with the increased color temperature and the pixel value of the red channel of the pixel in the sample image before the color temperature adjustment. The pixel value gain of the green channel of the pixel is determined according to the pixel value of the green channel of the pixel in the sample image with the increased color temperature and the pixel value of the green channel of the pixel in the sample image before the color temperature adjustment. The pixel value gain of the blue channel of the pixel is determined according to the pixel value of the blue channel of the pixel in the sample image with the increased color temperature and the pixel value of the blue channel of the pixel in the sample image before the color temperature adjustment.

At process d, a correspondence between the pixel value gain and the pixel value in the color channel is determined according to the pixel value gain in the color channel of the pixel and the pixel value in the color channel of the pixel in the sample image before color temperature adjustment.

In the embodiments, a correspondence between the pixel value gain the pixel value of the red channel when the color temperature adjustment ratio is greater than the first value is determined according to the pixel value gain of the red channel of the pixel and the pixel value of the red channel of the pixel in the sample image before color temperature adjustment. A correspondence between the pixel value gain the pixel value of the green channel when the color temperature adjustment ratio is greater than the first value is determined according to the pixel value gain of the green channel of the pixel and the pixel value of the green channel of the pixel in the sample image before color temperature adjustment. A correspondence between the pixel value gain the pixel value of the blue channel when the color temperature adjustment ratio is greater than the first value is determined according to the pixel value gain of the blue channel of the pixel and the pixel value of the blue channel of the pixel in the sample image before color temperature adjustment.

The red channel is taken as an example, and the green channel and the blue channel are similar. One possible implementation manner of the above process d is as follows. Because the pixel value gain has different gains in different pixel value intervals, a clustering processing is performed on the pixel value gains of the red channel of the pixel to obtain N types of pixel value gains, where N is an integer greater than 1. A cluster center gain of each type of pixel value gain is obtained. Then the N cluster center gains are smoothly connected to obtain a smooth curve. The smooth curve is, for example, an exponential curve. A function formula of the smooth curve can also be obtained by obtaining the smooth curve. According to the function formula of the smooth curve, the correspondence between the pixel value gain and the pixel value of the red channel is determined. The correspondence may be a function formula or a correspondence table. For example, the function formula of the smooth curve may be determined as the correspondence between the pixel value gain and the pixel value of the red channel, or, according to the function formula of the smooth curve, the pixel value gains corresponding to the pixel value from 0 to 255 are determined, and then a correspondence table between each pixel value from 0 to 225 and the corresponding pixel value gain is established.

For different color channels, the function formulas of the smooth curves corresponding to various color channels may be different. In some embodiments, for the color temperature adjustment ratio greater than the first value (for example, increasing the color temperature), the function formulas of the smooth curves corresponding to the three color channels are as follows, and the smooth curves corresponding to the three color channels are, for example, as shown in FIG. 3.

$$\{ \begin{matrix}{gain}_{r} = ( 1 - 1 / ( 1 + {e}^{- ( {x}_{r} - 148 ) / 5} ) ) * 0.18 + ( 1 / ( 1 + {e}^{- ( {x}_{r} - 220 ) / 5} ) - 1 ) * \\ 0.22 + 0.4 \\ {gain}_{g} = ( 1 / ( 1 + {e}^{- ( {x}_{g} - 220 ) / 5} ) - 1 ) * 0.04 + 0.01 \\ \begin{matrix}{gain}_{b} = ( 1 - 1 / ( 1 + {e}^{- ( {x}_{b} - 175 ) / 5} ) ) * 0.05 + ( 1 - 1 / ( 1 + {e}^{- ( {x}_{b} - 220 ) / 5} ) ) * \\ 0.2 + 0.02\end{matrix}\end{matrix}$$

where gainᵣ is the pixel value gain of the red channel, gain_{g} is the pixel value gain of the green channel, gain_{b} is the pixel value gain of the blue channel, xᵣ is the pixel value of the red channel, x_{g} is the pixel value of the green channel, and x_{b} is the pixel value of the blue channel.

In some embodiments, for the color temperature adjustment ratio smaller than the second value, the preset correspondence between the pixel value and the pixel value gain of the red channel, the preset correspondence between the pixel value and the pixel value gain of the green channel, and the preset correspondence between the pixel value and the pixel value gain of the blue channel can also be determined through the processes a-d, and the specific implementation process is similar, which is repeated here. The difference is that in these embodiments, when process a is performed, the preset adjustment ratio is smaller than the second value, for example, the second value is smaller than 0, and the sample image obtained after the color temperature adjustment is a sample image with a decreased color temperature.

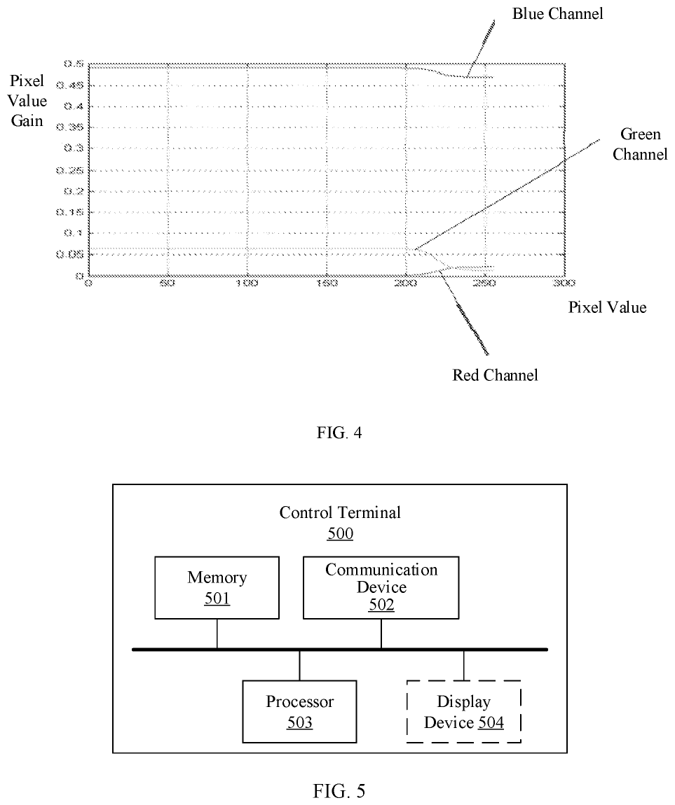

In some embodiments, for the color temperature adjustment ratio smaller than the second value (for example, decreasing the color temperature), the function formulas of the smooth curve corresponding to the three color channels are as follows, and the smooth curves corresponding to the three color channels are, for example, as shown in FIG. 4.

$$\{ \begin{matrix}{gain}_{r} = ( 1 / ( 1 + {e}^{- ( {x}_{r} - 220 ) / 5} ) - 1 ) * 0.02 + 0.02 \\ {gain}_{g} = ( 1 / ( 1 + {e}^{- ( {x}_{g} - 220 ) / 5} ) - 1 ) * 0.05 + 0.01 \\ {gain}_{b} = ( 1 - 1 / ( 1 + {e}^{- ( {x}_{b} - 220 ) / 5} ) ) * 0. 02 + 0.47\end{matrix}$$

where gainᵣ is the pixel value gain of the red channel, gain_{g} is the pixel value gain of the green channel, gain_{b} is the pixel value gain of the blue channel, xᵣ is the pixel value of the red channel, x_{g} is the pixel value of the green channel, and x_{b} is the pixel value of the blue channel.

In the embodiments of the present disclosure, the image to be adjusted is obtained, the pixel value gain of the pixel is determined according to the pixel value of the pixel in the image and the preset correspondence between the pixel value and the pixel value gain, and the color temperature of the pixel is adjusted according to the pixel value and the pixel value gain of the pixel, and the color temperature adjustment ratio. In the embodiments, a color temperature estimation process does not need to be performed, therefore a color temperature adjustment process is simplified and a color temperature adjustment efficiency is improved, which can meet the need of real-time adjustment of the color temperature. If the above-described color temperature adjustment tool is Photoshop, the color temperature adjustment effect similar to that of Photoshop can be achieved through the embodiments.

A computer storage medium is provided according to an embodiment of the disclosure. The computer storage medium stores program instructions, and when the program is executed, some or all of the processes of the color temperature adjustment method in the above embodiments are performed.

FIG. 5 is a schematic structural diagram of a control terminal according to an embodiment of the disclosure. As shown in FIG. 5, the control terminal 500 of the embodiments may be used to control a movable platform and the control terminal 500 includes a memory 501, a communication device 502 and a processor 503. The memory 501, the communication device 502, and the processor 503 may be communicatively connected through a bus. The processor 503 may be a central processing unit (CPU), and the processor 503 may also be another general-purpose processor, a digital signal processor (DSP), an application specific integrated circuit (ASIC), a field-programmable gate array (FPGA) or another programmable logic device, a discrete gate or a transistor logic device, or a discrete hardware component, etc. The general-purpose processor may be a microprocessor or the processor may also be any conventional processor or the like.

The memory 501 is configured to store a preset correspondence between a pixel value and a pixel value gain.

The communication device 502 is configured to receive shot images sent by a movable platform. The movable platform is, for example, a UAV.

The processor 503 is configured to determine the pixel value gain of a pixel in the image according to the pixel value of the pixel and a preset correspondence between the pixel value and the pixel value gain, and adjust a color temperature of the pixel according to the pixel value and the pixel value gain of the pixel, and a color temperature adjustment ratio.

In some embodiments, the pixel value includes the pixel value in at least one color channel.

In some embodiments, the at least one color channel includes at least one of a red channel, a green channel, or a blue channel.

In some embodiments, the preset correspondence between the pixel value and the pixel value gain includes a preset correspondence between the pixel value and the pixel value gain in each color channel in the at least one color channel.

In some embodiments, the preset correspondence between the pixel value and the pixel value gain in each color channel in the at least one color channel includes a preset correspondence between the pixel value and the pixel value gain in each color channel in the at least one color channel for a color temperature adjustment ratio greater than a first value.

In some embodiments, the processor 503 is configured to determine the pixel value gain in each color channel in the at least one color channel of the pixel according to the pixel value in each color channel in the at least one color channel of the pixel in the image, and the preset correspondence between the pixel value and the pixel value gain in each color channel in the at least one color channel for the color temperature adjustment ratio greater than the first value if the color temperature adjustment ratio is greater than the first value.

In some embodiments, the preset correspondence between the pixel value and the pixel value gain in each color channel in the at least one color channel includes a preset correspondence between the pixel value and the pixel value gain in each color channel in the at least one color channel for a color temperature adjustment ratio smaller than a second value.

In some embodiments, the processor 503 is configured to determine the pixel value gain in each color channel in the at least one color channel of the pixel according to the pixel value in each color channel in the at least one color channel of the pixel in the image, and the preset correspondence between the pixel value and the pixel value gain in each color channel in the at least one color channel for the color temperature adjustment ratio smaller than the second value if the color temperature adjustment ratio is smaller than the second value.

In some embodiments, the processor 503 is further configured to use a color temperature adjustment tool to increase the color temperature of a sample image by a preset color temperature adjustment ratio to obtain a sample image after color temperature adjustment, obtain the pixel value in the color channel of the pixel in the sample image after color temperature adjustment for each color channel in the at least one color channel, determine the pixel value gain in the color channel of the pixel according to the pixel value in the color channel of the pixel in the sample image after color temperature adjustment and the pixel value in the color channel of the pixel in the sample image before color temperature adjustment, and determine the correspondence between the pixel value gain and the pixel value in the color channel according to the pixel value gain in the color channel of the pixel and the pixel value in the color channel of the pixel in the sample image before color temperature adjustment.

When the preset color temperature adjustment ratio is greater than the first value, the determined correspondence between the pixel value gain and the pixel value in the color channel is a preset correspondence between the pixel value and pixel value gain in the color channel for the color temperature adjustment ratio greater than the first value. When the preset color temperature adjustment ratio is smaller than the second value, the determined correspondence between the pixel value gain and the pixel value in the color channel is a preset correspondence between the pixel value and the pixel value gain in the color channel for the color temperature adjustment ratio smaller than the second value. The first value is greater than or equal to the second value.

In some embodiments, when the preset color temperature adjustment ratio is greater than the first value, the preset color temperature adjustment ratio is a maximum color temperature adjustment ratio in the color temperature adjustment tool. When the preset color temperature adjustment ratio is smaller than the second value, the preset color temperature adjustment ratio is a minimum color temperature adjustment ratio in the color temperature adjustment tool.

In some embodiments, the processor 503 is configured to perform clustering processing on the pixel value gain in the color channel of the pixel to obtain N types of pixel value gains, where N is an integer greater than 1, obtain a cluster center gain of each type of pixel value gain, obtain a smooth curve by smoothly connecting N cluster center gains, and determine the correspondence between the pixel value gain and the pixel value in the color channel according to a function formula of the smooth curve.

In some embodiments, the processor 503 is configured to determine the function formula of the smooth curve as the correspondence between the pixel value gain and the pixel value in the color channel, or according to the function formula of the smooth curve, determine the pixel value gains corresponding to the pixel value from 0 to 255, and establish a correspondence table between the pixel value from 0 to 225 and the corresponding pixel value gain.

In some embodiments, the control terminal 500 of the embodiments further includes a display device 504. The display device 504 is, for example, a touch screen.

The display device 504 is used for displaying an image after the color temperature adjustment.

In some embodiments, the image to be adjusted is a video image captured in real time by the movable platform.

The control terminal of the embodiments can be used to execute the technical solutions of the control terminal in the above-described method embodiments of the present disclosure, and the implementation principles and technical effects are similar, which are not repeated here.

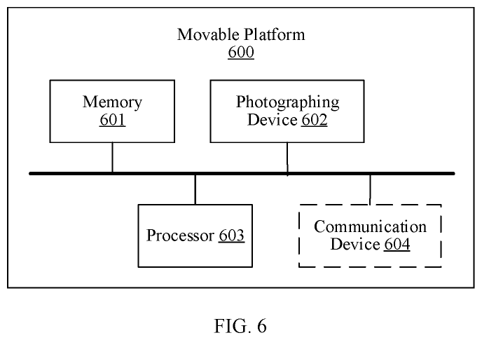

FIG. 6 is a schematic structural diagram of a movable platform according to an embodiment of the present disclosure. As shown in FIG. 6, the movable platform 600 of the embodiments includes a memory 601, a photographing device 602, and a processor 603. The memory 601, the photographing device 602 and the processor 603 may be may be communicatively connected through a bus. The processor 603 may be a CPU, and the processor 603 may also be another general-purpose processor, a DSP, an ASIC, a FPGA or another programmable logic device, a discrete gate or a transistor logic device, a discrete hardware component, or the like. The general-purpose processor may be a microprocessor or the processor may also be any conventional processor or the like.

The memory 601 is configured to store a preset correspondence between a pixel value and a pixel value gain.

The photographing device 602 is configured to capture images.

The processor 603 is configured to determine the pixel value gain of a pixel in the image according to the pixel value of the pixel and a preset correspondence between the pixel value and the pixel value gain, and adjust a color temperature of the pixel according to the pixel value and the pixel value gain of the pixel, and a color temperature adjustment ratio.

In some embodiments, the pixel value includes the pixel value in at least one color channel.

In some embodiments, the at least one color channel includes at least one of a red channel, a green channel, or a blue channel.

In some embodiments, the preset correspondence between the pixel value and the pixel value gain includes a preset correspondence between the pixel value and the pixel value gain in each color channel in the at least one color channel.

In some embodiments, the preset correspondence between the pixel value and the pixel value gain in each color channel in the at least one color channel includes a preset correspondence between the pixel value and the pixel value gain in each color channel in the at least one color channel for a color temperature adjustment ratio greater than a first value.

In some embodiments, the processor 603 is configured to determine the pixel value gain in each color channel in the at least one color channel of the pixel according to the pixel value in each color channel in the at least one color channel of the pixel in the image, and the preset correspondence between the pixel value and the pixel value gain in each color channel in the at least one color channel for the color temperature adjustment ratio greater than the first value if the color temperature adjustment ratio is greater than the first value.

In some embodiments, the preset correspondence between the pixel value and the pixel value gain in each color channel in the at least one color channel includes a preset correspondence between the pixel value and the pixel value gain in each color channel in the at least one color channel for a color temperature adjustment ratio smaller than a second value.

In some embodiments, the processor 603 is configured to determine the pixel value gain in each color channel in the at least one color channel of the pixel according to the pixel value in each color channel in the at least one color channel of the pixel in the image, and the preset correspondence between the pixel value and the pixel value gain in each color channel in the at least one color channel for the color temperature adjustment ratio smaller than the second value if the color temperature adjustment ratio is smaller than the second value.

In some embodiments, the correspondence between the pixel value and the pixel value gain in each color channel includes a function formula of a smooth curve, or a correspondence table between the pixel value from 0 to 225 and the corresponding pixel value gain.

In some embodiments, the movable platform 600 may further include a communication device 604.

The communication device 604 is configured to send the image after the color temperature adjustment to the control terminal.

The movable platform of the embodiments can be used to implement the technical solutions of the UAV in the above-described method embodiments of the present disclosure, and the implementation principles and technical effects are similar, which are not repeated here.

A person of ordinary skill in the art can understand that all or some of the processes of the above method embodiments can be implemented by a program instructing relevant hardware. The foregoing program can be stored in a computer readable storage medium. When the program is executed, the processes of the above-described method embodiments are executed. The storage medium includes a medium that can store program codes, such as a read-only memory (ROM), a random access memory (RAM), a magnetic disk or an optical disk, etc.

Finally, it should be noted that the above embodiments are only used to illustrate the technical solution of the present disclosure, rather than to limit it. Although the present disclosure has been described in detail with reference to the foregoing embodiments, those of ordinary skill in the art should understand that the technical solutions described in the foregoing embodiments can still be modified and some or all of the technical features can be equivalently replaced. These modifications or replacements do not make the essence of their corresponding technical solutions deviate from the technical solutions of the embodiments of the present disclosure.

What is claimed is:

1. A color temperature adjustment method comprising:
obtaining an image to be adjusted;
determining a pixel value gain of a pixel in the image according to a pixel value of the pixel and a preset gain-value correspondence between the pixel value and the pixel value gain; and
adjusting a color temperature of the pixel according to the pixel value and the pixel value gain of the pixel, and a color temperature adjustment ratio.

2. The method of claim 1, wherein the pixel value includes the pixel value of a color channel.

3. The method of claim 2, wherein the color channel includes a red channel, a green channel, or a blue channel.

4. The method of claim 2, wherein the preset gain-value correspondence includes:
a preset gain-value correspondence in the color channel.

5. The method of claim 4, wherein the preset gain-value correspondence in the color channel includes:
a preset gain-value correspondence in the color channel for color temperature adjustment ratios greater than a ratio value.

6. The method of claim 5, wherein determining the pixel value gain of the pixel includes:
in responding to the color temperature adjustment ratio being greater than the ratio value, determining the pixel value gain in the color channel of the pixel according to the pixel value in the color channel of the pixel, and the preset gain-value correspondence in the color channel corresponding to the ratio value.

7. The method of claim 4, wherein the preset gain-value correspondence in the color channel include:
a preset gain-value correspondence in the color channel for color temperature adjustment ratios smaller than a ratio value.

8. The method of claim 7, wherein determining the pixel value gain of the pixel includes:
in response to the color temperature adjustment ratio being smaller than the second value, determining the pixel value gain in the color channel of the pixel according to the pixel value in the color channel of the pixel, and the preset gain-value correspondence in the color channel corresponding to the ratio value.

9. The method of claim 4, wherein the preset gain-value correspondence in the color channel is obtained by:
increasing, using a color temperature adjustment tool, a color temperature of a sample image by a preset color temperature adjustment ratio to obtain an adjusted sample image;
obtaining pixel values in the color channel of pixels in the adjusted sample image;
determining pixel value gains in the color channel of the pixels according to the pixel values in the color channel of the pixels in the adjusted sample image and pixel values in the color channel of the pixels in the sample image; and
determining the gain-value correspondence in the color channel according to the pixel value gains in the color channel of the pixels and the pixel values in the color channel of the pixels in the sample image, wherein:
when the preset color temperature adjustment ratio is greater than a first ratio value, the gain-value correspondence in the color channel is a preset gain-value correspondence in the color channel corresponding to the first ratio value; and
when the preset color temperature adjustment ratio is smaller than a second ratio value smaller than the first ratio value, the gain-value correspondence in the color channel is a preset gain-value correspondence in the color channel corresponding to the second ratio value.

10. The method of claim 9, wherein:
when the preset color temperature adjustment ratio is greater than the first ratio value, the preset color temperature adjustment ratio is a maximum color temperature adjustment ratio in the color temperature adjustment tool; and
when the preset color temperature adjustment ratio is smaller than the second ratio value, the preset color temperature adjustment ratio is a minimum color temperature adjustment ratio in the color temperature adjustment tool.

11. The method of claim 9, wherein determining the gain-value correspondence in the color channel according to the pixel value gains in the color channel of the pixels and the pixel values in the color channel of the pixel in the sample image includes:
performing clustering processing on the pixel value gains in the color channel of the pixels to obtain N types of pixel value gains, N being an integer greater than 1;
obtaining a cluster center gain of each of the N types of pixel value gains;
obtaining a smooth curve by smoothly connecting the N cluster center gains; and
determining the gain-value correspondence in the color channel according to a function formula of the smooth curve.

12. The method of claim 11, wherein determining the gain-value correspondence in the color channel according to the function formula of the smooth curve includes:
determining the function formula of the smooth curve as the gain-value correspondence in the color channel; or
determining the pixel value gains corresponding to pixel values from 0 to 255 according to the function formula of the smooth curve and establishing a gain-value correspondence table between the pixel values from 0 to 225 and the corresponding pixel value gains.

13. The method of claim 1, further comprising:
displaying an adjusted image after the color temperature adjustment.

14. The method of claim 1, wherein the image to be adjusted includes a video image captured in real time by a photographing device.

15. A control terminal comprising:
a memory storing a preset gain-value correspondence between a pixel value and a pixel value gain;
a communication device configured to receive an image sent by a movable platform; and
a processor configured to:
determine a pixel value gain of a pixel in the image according to a pixel value of the pixel and the preset gain-value correspondence; and
adjust a color temperature of the pixel according to the pixel value and the pixel value gain of the pixel, and a color temperature adjustment ratio.

16. A movable platform comprising:
a photographing device configured to capture an image;
a memory storing a preset gain-value correspondence between a pixel value and a pixel value gain; and
a processor configured to:
determine a pixel value gain of a pixel in the image according to a pixel value of the pixel and the preset gain-value correspondence; and
adjust a color temperature of the pixel according to the pixel value and the pixel value gain of the pixel, and a color temperature adjustment ratio.

17. The movable platform of claim 16, wherein the pixel value includes the pixel value of a color channel.

18. The movable platform of claim 16, wherein the preset gain-value correspondence includes:
a preset gain-value correspondence in the color channel.

19. The movable platform of claim 18, wherein the preset gain-value correspondence in the color channel includes:
a preset gain-value correspondence in the color channel for color temperature adjustment ratios greater than a ratio value.

20. The movable platform of claim 16, wherein an adjusted image after the color temperature adjustment is sent to a control terminal.
